(19) United States
(12) Patent Application Publication
(10) Pub. No.: US 2015/0191574 A1
(43) Pub. Date: Jul. 9, 2015

(54) PREPREG AND METHOD FOR MANUFACTURING THE SAME

(71) Applicant: INDUSTRIAL TECHNOLOGY RESEARCH INSTITUTE, Hsinchu (TW)

(72) Inventors: Wen-Chin LEE, Taipei City (TW); Meng-Song YIN, Hsinchu City (TW); Mean-Jue TUNG, Jincheng Township (TW); Wei-Ta YANG, Jhongli City (TW)

(73) Assignee: INDUSTRIAL TECHNOLOGY RESEARCH INSTITUTE, Hsinchu (TW)

(21) Appl. No.: 14/566,860

(22) Filed: Dec. 11, 2014

Related U.S. Application Data
(60) Provisional application No. 61/924,077, filed on Jan. 6, 2014.

(30) Foreign Application Priority Data
Aug. 7, 2014 (TW) 103127030

(51) Int. Cl. C08J 5/24; B05D 3/06; C08K 7/14

(52) U.S. Cl. CPC C08J 5/24; C08K 7/14; B05D 3/067; C08J 2333/14

(57) ABSTRACT

Disclosed is a prepreg, including a reinforcing material and a polymer, wherein the polymer is polymerized from a monomer, an oligomer, or combinations thereof of an organic rod-like molecule. The organic rod-like molecule has at least one photo-polymerizable group. The organic rod-like molecule has the magnetic susceptibility along its long-axis direction (M1) greater than the magnetic susceptibility along other directions (M2), and the magnetic susceptibility ratio (M1/M2) is greater than 0.01 and less than 1.

### CROSS REFERENCE TO RELATED APPLICATIONS

This application claims the benefit of U.S. Provisional Application No. 61/924,077 filed on Jan. 6, 2014, the entirety of which is incorporated by reference herein. The present application is based on, and claims priority from, Taiwan Application Serial Number 103127030, filed on Aug. 7, 2014, the disclosure of which is hereby incorporated by reference herein in its entirety

### TECHNICAL FIELD

The technical field relates to a prepreg, and in particular to the composition and manufacture thereof.

### BACKGROUND

In precise products, e.g. high density multi-layered circuit boards, composite material with a low coefficient of thermal expansion (CTE) along the direction of its thickness has a high applicability. For example, laminated sheets in the multi-layered circuit board (so-called prepregs) are usually prepared by impregnating glass fabric into a resin. The prepreg has a high dimension stability and low CTE along its surface direction due to the support of the glass fabric. The dimension stability along the direction of its thickness of the prepreg should be enhanced due to lack of the support of the glass fabric.

Commercially available laminated sheets in circuit boards have an average CTE over 15 ppm/°C. along the direction of its thickness, and therefore fail to satisfy the processing requirement of the high density circuits in high-level electronic products. As such, the CTE along the direction of its thickness of the laminated sheets needs to be reduced.

### SUMMARY

One embodiment of the disclosure provides a prepreg, comprising: a reinforcing material; and a polymer, wherein the polymer is polymerized from monomer, oligomer, or combinations thereof of an organic rod-like molecule. The organic rod-like molecule has at least one photo-polymerizable group. The organic rod-like molecule has the magnetic susceptibility along its long-axis direction (M1) that is greater than the magnetic susceptibility along other directions (M2), i.e. M1 is less negative than M2, and the magnetic susceptibility ratio (M1/M2) is greater than 0.01 and less than 1.

One embodiment of the disclosure provides a method of forming a prepreg, comprising: combining a varnish and a reinforcing material to form a film, wherein the varnish comprises a photo initiator, a solvent, and a monomer, an oligomer, or combinations thereof of an organic rod-like molecule, wherein the organic rod-like molecule has at least one photo-polymerizable group, the organic rod-like molecule has the magnetic susceptibility along its long-axis direction (M1) greater than the magnetic susceptibility along other directions (M2), and the magnetic susceptibility ratio (M1/M2) is greater than 0.01 and less than 1; applying a magnetic field to the film for arranging the organic rod-like molecule, such that the long-axis of the organic rod-like molecule is parallel to the magnetic field and vertical to the surface of the film, wherein the magnetic field is along a direction vertical to the surface of the film; and exposing the film to UV radiation, such that the organic rod-like molecule arranged by the magnetic field is polymerized to form a polymer, wherein the polymer and the reinforcing material are composited to form a prepreg.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 shows continuous formation process of the prepregs in one embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are shown schematically in order to simplify the drawing.

One embodiment of the disclosure provides a method of forming a prepreg as described below. First, preparing a varnish including 100 parts by weight of monomer, oligomer, or combinations thereof of an organic rod-like molecule, 0.1 to 5 parts by weight of photo initiator, and 0 to 60 parts by weight of solvent. The organic rod-like molecule has at least one photo-polymerizable group (e.g. carbon-carbon double bond). The organic rod-like molecule has the magnetic susceptibility along its long-axis direction (M1) greater than the magnetic susceptibility along other directions (M2), and the magnetic susceptibility ratio (M1/M2) is greater than 0.01 and less than 1. In one embodiment, the magnetic susceptibility ratio (M1/M2) is greater than 0.1 and less than 1. In one embodiment, the organic rod-like molecule is one of Formulae 1 to 10 or combinations thereof.

R¹—O—Ph-A⁰-Ph-O—R² (Formula 1)

R¹—O—Ph-A¹-Ph-A²-Ph-O—R² (Formula 2)

R¹—O—Ph-A¹-Ph-A²-Ph-A³-Ph-O—R² (Formula 3)

R¹—O-Ph-A¹-Ph-A²-Ph-A³-Ph-A⁴-Ph-O—R² (Formula 4)

R¹—O-Ph-A-Ph-A²-Ph-A³-Ph-A⁴-Ph-A⁵-Ph-O—R² (Formula 5)

R¹—O-Ph-A¹-Ph-A²-Ph-A³-Ph-A⁴-Ph-A⁵-Ph-A⁶-Ph-O—R² (Formula 6)

R¹—O-Ph-A¹-Ph-A²-Ph-A³Ph-A⁴-Ph-A⁵-Ph-A⁶-Ph-A⁷-Ph-O—R² (Formula 7)

R¹—O-Ph-A¹-Ph-A²-Ph-A³-Ph-A⁴-Ph-A⁵-Ph-A⁶-Ph-A⁷-Ph-A⁸-Ph-O—R² (Formula 8)

R₁—O-Ph-A¹-Ph-A²-Ph-A³-Ph-A⁴-Ph-A⁵-Ph-A⁶-Ph-A⁷-Ph-A⁸-Ph-A⁹-Ph-O—R² (Formula 9)

R¹—O-Ph-A¹-Ph-A²-Ph-A³-Ph-A⁴-Ph-A⁵-Ph-A⁶-Ph-A⁷-Ph-A⁸-Ph-A⁹-Ph-A¹⁰-Ph-O—R² (Formula 10)

In Formulae 1 to 10, Ph is a phenyl group without substitution or a phenyl group substituted with NO₂, OH, OCH₃, CH₃, CF₃, F, Cl, or Br. A⁰ is —C≡C—. Each of A¹, A², A^{b 3}, A⁴, A⁵, A⁶, A⁷, A⁸, A⁹, and A¹⁰ is independently of—CH₂—, —O—, —(C═O)—, —(CH═CH)—, —C≡C—, —O—(C═O)—, —(NH)—(C═O)—, or a single bond. Each of R¹ and R² is independently of —R³—O—(C═O)—C═CH₂, and R³ is C₂-C₁₂ alkylene group.

After exposure to UV radiation, the photo initiator will be cracked to form radicals for polymerizing the photo-polymerizable groups of the organic rod-like molecules. An overly low amount of the photo initiator cannot efficiently initiate the polymerization. An overly high amount of the photo initiator will degrade the polymer properties and increase the control requirement of the surrounding light during processing. In one embodiment, the solvent can be toluene (CAS No.: 108-88-3), methyl ethyl ketone (CAS No.: 78-93-9), dimethylformamide (CAS No.: 68-12-2), or y-butyrolactone (CAS No.: 96-48-0). The solvent may adjust the varnish viscosity. An overly high or low amount of the varnish may result in an overly thin or thick varnish which cannot be easily combined with a reinforcing material to form a film. In other embodiments of the disclosure, the varnish may further include 0.5 to 100 parts by weight of an epoxy resin such as EPON 828 or NPCN-704 and 0.5 to 100 parts by weight of an epoxy resin curing agent such as Dicy (CAS No.:461-58-5), DDS (CAS No.: 80-08-0) or Novolac.

Thereafter, the varnish is combined with a reinforcing material to form a film. On the basis of 100 parts by weight of monomer, oligomer, or combinations thereof of the organic rod-like molecule, the amount of a reinforcing material is 10 to 200 parts by weight. An overly high amount of the reinforcing material will result in difficulty in the following processes, low yield of products, and weak adherence between the prepreg and a copper foil. An overly low amount of the reinforcing material cannot efficiently enhance the mechanical strength of the film. In one embodiment of the disclosure, the reinforcing material can be glass, ceramic, carbon material, resin, or combinations thereof. In one embodiment, the reinforcing material has a form of fibers, powders, sheets, fabrics, or combinations thereof. In one embodiment, the step of combining the varnish and the reinforcing material is dispersing the reinforcing material in the varnish to form dispersion, and coating the dispersion onto a carrier. In another embodiment, the reinforcing material is a fabric such as glass fabric, and the step of combining the varnish and the reinforcing material is impregnating the reinforcing material (e.g. fiber or fabric) into the varnish. In a further embodiment, the step of combining the varnish and the reinforcing material is coating the varnish onto the reinforcing material.

Subsequently, a magnetic field is applied to the film for arranging the organic rod-like molecule, such that the long-axis of the organic rod-like molecule is parallel to the magnetic field and vertical to the surface of the film. The magnetic field is along a direction vertical to the surface of the film. In one embodiment, the magnetic field can be a magnetostatic field or a variable pulsed magnetic field, and the magnetic field has a strength of 0.1T to 10T. An overly low magnetic field strength cannot efficiently arrange the organic rod-like molecule. An overly high magnetic field strength needs overly large magnetic field equipment and additional safety precautions during production, thereby greatly increasing the mass-production cost. In one embodiment, the magnetic field is applied to the film for a period of 1 second to 600 seconds (or 5 seconds to 100 seconds). An overly short period of applying the magnetic field cannot efficiently arrange the organic rod-like molecule. An overly long period of applying the magnetic field will lengthen the production time.

The film is then or simultaneously exposed to UV radiation, thereby polymerizing the organic rod-like molecule (arranged by the magnetic field) to form a polymer. The polymer and the reinforcing material are composited to form a prepreg. The film is exposed to the UV radiation for a period of less than 10 seconds, e.g. greater than 0 second and less than 10 seconds, such that the organic rod-like molecule in the film is efficiently cured.

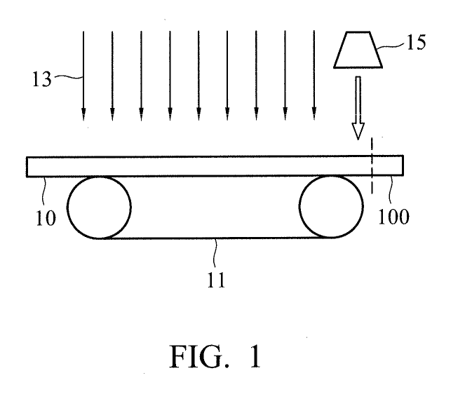

It should be understood that the above process can be a continuous process (for example, a roll to roll process). As shown in FIG. 1, the film 10 of a combination of the varnish and the reinforcing material can be formed on a conveyor belt 11. The magnetic field 13 is then applied to the film 10. The period of applying the magnetic field 13 is determined by the transfer speed of the conveyor belt 11. A UV radiation lamp 15 is disposed on the end of the conveyor belt 11. After being arranged by the magnetic field and cured by the UV radiation, the film 10 is converted to a prepreg 100. In one embodiment, the UV radiation lamp 15 and the magnetic field 13 can be located in the same position to be simultaneously applied to the film. Compared to a thermal polymerization mechanism, the above photopolymerization mechanism is faster. In addition to reducing the production time, the photopolymerization mechanism is more timesaving than the thermal polymerization mechanism in the continuous process.

In another embodiment, the reinforcing material can be put on the conveyor belt, and the varnish is coated directly on the reinforcing material to form the film. The following steps, such as applying the magnetic field to the film and curing the film by the UV radiation, are similar to those described above.

In one embodiment of the disclosure, the reinforcing material can be directly transferred by a roll (without the conveyor belt) to be impregnated in the varnish for forming the film. The following steps, such as applying the magnetic field to the film and curing the film by the UV radiation, are similar to those described above.

The prepreg can be laminated onto a copper foil to form a copper clad laminate. Because the prepreg has a lower CTE along the direction of its thickness than that of conventional prepregs, the burst problem can be efficiently reduced and the process yield can be enhanced.

Below, exemplary embodiments will be described in detail with reference to the accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

### Example 1

1 g of 1,4-Bis-[4-(3-acryloyloxypropyloxy)benzoyloxy]-2-methylbenzene(CAS No.: 174063-87-7) was selected as the organic monomer of rod-like structure. 0.03 g of 1-hydroxy-cyclohexyl-phenyl-ketone (CAS No.: 947-19-3) was selected as a photo initiator. The organic rod-like molecule and the photo initiator were mixed, and then put on a glass substrate to be heated to 80° C. After the mixture was melted, another glass substrate was put onto the glass substrate, and the two substrates were separated by a spacer with a thickness of 700 μm. The above structure was put in a permanent magnet device with a magnetic field strength of 2 T (still at 80° C). , wherein the magnetic field direction was vertical to the substrate surface, such that the direction of the long-axis of the organic rod-like molecule was parallel to the magnetic field direction. The magnetic field was applied to the mixture for 10 minutes, and UV radiation was then exposed to the mixture for polymerizing the organic rod-like molecule (arranged by the magnetic field), thereby curing the mixture. The cured sample was cut to have an area of 0.7 cm*0.7 cm (and a thickness of about 700 μm), and then measured by TMA to obtain a dimension change of the sample along the direction of its thickness during heating the sample. The sample had a CTE along the direction of its thickness at a temperature range of 30° C. to 110° C., as shown in Table 1.

### Example 2

Example 2 was similar to Example 1, and the difference in Example 2 was the magnetic field strength of the permanent magnet device being reduced from 2 T to 1 T. The other conditions in Example 2, such as the compositions of the mixture, the temperature for heating the mixture, the magnetic field direction, the period of applying the magnetic field, the UV radiation exposure, and the sample size after cutting, were similar to those in Example 1. The cut sample was measured by TMA to obtain a dimension change along the direction of its thickness during heating the sample. The sample had a CTE along the direction of its thickness at a temperature range of 30° C. to 110° C. , as shown in Table 1.

### Example 3

Example 3 was similar to Example 1, and the difference in Example 3 was the magnetic field strength of the permanent magnet device being reduced from 2 T to 0.1 T. The other conditions in Example 3, such as the compositions of the mixture, the temperature for heating the mixture, the magnetic field direction, the period of applying the magnetic field, the UV radiation exposure, and the sample size after cutting were similar to those in Example 1. The cut sample was measured by TMA to obtain a dimension change along the direction of its thickness during heating the sample. The sample had a CTE along the direction of its thickness at a temperature range of 30° C. to 110° C., as shown in Table 1.

### Comparative Example 1

Comparative Example 1 was similar to Example 1, and the difference in Comparative Example 1 was that no magnetic field was applied. The other conditions in Comparative Example 1, such as the compositions of the mixture, the temperature for heating the mixture, the UV radiation exposure, and the sample size after cutting were similar to those in Example 1. The cut sample was measured by TMA to obtain a dimension change along the direction of its thickness during heating the sample. The sample had a CTE along the direction of its thickness at a temperature range of 30° C. to 110° C. as shown in Table 1.

TABLE 1

| | CTE (μm/(m · ° C.) 30-110° C. |
|---|---|
| Comparative Example 1 | 60 |
| Example 1 | −98 |
| Example 2 | −25 |
| Example 3 | −9 |

In Table 1, the positive CTE means expansion, and the negative CTE means contraction. While the degree of contraction in Example 1 was higher than the degree of expansion in Comparative Example 1, the following application may tolerate contraction (but not tolerate expansion). For example, while the glass fabric may reduce the degree of contraction, the mixture in the impregnated glass fabric may contract (but not expand) after being heated. On the other hand, if another crosslinker is added to the varnish, the expansion properties of the crosslinker may compensate for the contraction properties of the above mixture.

As shown in Table 1, the sample formed without applying the magnetic field in Comparative Example 1 had a positive CTE (expansion) along the direction of its thickness, and the samples formed by applying the magnetic field in Examples 1-3 had a negative CTE (contraction) along the direction of their thicknesses. Obviously, the process of the disclosure was beneficial in forming a sample with a negative CTE along the direction of its thickness.

### Example 4

1 g of 1,4-bis-[4-(3-acryloyloxypropyloxy)benzoyloxy]-2-methylbenzene (CAS No.: 174063-87-7) was selected as the organic monomer of rod-like structure, and 0.03 g of 1-hydroxy-cyclohexyl-phenyl-ketone (CAS No.: 947-19-3) was selected as an photo initiator. The organic rod-like molecule and the photo initiator were mixed, and then put on a glass substrate to be heated to 80° C. After melting the mixture, a glass fabric with an area of 2 cm×2 cm (2116 commercially available from Taiwanglass Co. Ltd.) was put into the melted mixture, and another glass substrate was capped thereon to squeeze out air between the glass substrates. The above structure was put in a permanent magnet device with a magnetic field strength of 2 T (remained at 80° C.), wherein the magnetic field direction was vertical to the substrate surface, such that the direction of the long-axis of the organic rod-like molecule was parallel to the magnetic field direction. The magnetic field was applied to the mixture for 10 minutes, and UV radiation was then exposed to the mixture for polymerizing the organic rod-like molecule (arranged by the magnetic field), thereby curing the mixture. The cured mixture and the glass fabric were composited to form a prepreg. The prepreg was cut to have an area of 0.7 cm*0.7 cm, an average thickness (about 800 μm), and a flat surface. The cut prepreg was then measured by TMA to obtain a dimension change along the direction of its thickness during heating the sample. The sample had an expansion ratio in the Z-axis along the direction of its thickness at a temperature range of 50° C. to 288° C., as shown in Table 2.

### Comparative Example 2

Comparative Example 2 was similar to Example 4, and the difference in Comparative Example 2 was no magnetic field being applied. The other conditions in Comparative Example 2, such as the compositions of the mixture, the temperature for heating the mixture, the UV radiation exposure, and the sample size after cutting were similar to those in Example 4. The cut sample was measured by TMA to obtain a dimension change along the direction of its thickness during heating the sample. The sample had an expansion ratio in the Z-axis along the direction of its thickness at a temperature range of 50° C. to 288° C., as shown in Table 2.

TABLE 2

| | Expansion ratio in the Z |
|---|---|
| | axis from 50° C. to 288° C. |
| Comparative Example 2 | 5.2% |
| Example 4 | 4.4% |

As shown in Comparison in Table 2, the sample formed without applying the magnetic field in Comparative Example 2 had the greater expansion ratio in the Z-axis along the direction of its thickness than that of the sample formed by applying the magnetic field in Example 4. Obviously, the process of the disclosure was beneficial to form a sample with a lesser expansion ratio in the Z-axis along the direction of its thickness.

### Comparative Example 3

Comparative Example 3 was similar to Example 1, and the difference in Comparative Example 3 was a photo polymerizable non-rod-like monomer being used. The other conditions in Comparative Example 3, such as the temperature for heating the mixture, the magnetic field direction, the period of applying the magnetic field, the UV radiation exposure, and the sample size after cutting were similar to those in Example 1. 1 g of bisphenol A glycerolate (1 glycerol/phenol) diacrylate , CAS no.:4687-94-9) was selected as the monomer of non-rod-like structure, and 1-hydroxy-cyclohexyl-phenyl-ketone (CAS No.: 947-19-3) was selected as a photo initiator. The cured sample was cut to have an area of 0.7 cm*0.7 cm (thickness of about 700 μm), and then measured by TMA to obtain a dimension change along the direction of its thickness during heating the sample. The sample had a CTE along the direction of its thickness at a temperature range of 30° C. to 110° C., as shown in Table 3.

TABLE 3

| | CTE(μm/(m · ° C.) 30-110° C. |
|---|---|
| Comparative Example 3 | 58 |
| Example 1 | −98 |

As shown in comparison in Table 3, the sample formed of the non-rod-like molecule in Comparative Example 3 had a positive CTE (expansion) along the direction of its thickness, and the sample formed of the rod-like molecule in Example 1 had a negative CTE (contraction) along the direction of its thickness. Obviously, the organic rod-like molecule in the disclosure was beneficial to form a sample having a negative CTE along the direction of its thickness under the same magnetic field strength of formation.

The magnetic susceptibility of the organic rod-like molecule could be simulated and evaluated by the commercial software Gaussian (available from Gaussian Inc.). For example, the magnetic susceptibility of 1,4-bis-[4-(3-acryloyloxypropyloxy)benzoyloxy-2-methylbenzene in Examples 1-4 was calculated, such that the magnetic susceptibility along its long-axis direction (Z) and the average magnetic susceptibility along a direction vertical to its long-axis were evaluated and tabulated in Table 4.

TABLE 4
Magnetic susceptibility (cm³ · mol⁻¹):

| Average magnetic | Magnetic | |
|---|---|---|
| susceptibility | susceptibility | Magnetic |
| along a direction | along its long- | susceptibility |
| vertical to its | axis direction | ratio |
| long-axis (X or Y) | (Z) | [Z/(X or Y)] |
| −339*10⁻⁶ | −205*10⁻⁶ | 0.6 |

As shown in table 4, the organic rod-like molecule has a magnetic susceptibility along its long-axis direction (Z) greater than a magnetic susceptibility along other directions, and the magnetic susceptibility ratio (Z/(X or Y)) is greater than 0.01 and less than 1.

It will be apparent to those skilled in the art that various modifications and variations can be made to the disclosed methods and materials. It is intended that the specification and examples be considered as exemplary only, with a true scope of the disclosure being indicated by the following claims and their equivalents.

What is claimed is:

1. A prepreg, comprising:
a reinforcing material; and
a polymer,
wherein the polymer is polymerized from monomer, oligomer, or combinations thereof of an organic rod-like molecule, the organic rod-like molecule has at least one photo-polymerizable group, the organic rod-like molecule has a magnetic susceptibility along its long-axis direction (M1) greater than a magnetic susceptibility along other directions (M2), and the magnetic susceptibility ratio (M1/M2) is greater than 0.01 and less than 1.

2. The prepreg as claimed in claim 1, wherein the organic rod-like molecule is one of Formulae 1 to 10 or combinations thereof:
R¹—O-Ph-A⁰-Ph-O—R² (Formula 1)
R¹—O-Ph-A¹-Ph-A²-Ph-O—R² (Formula 2)
R¹—O-Ph-A¹-Ph-A²-Ph-A³-Ph-O—R² (Formula 3)
R¹—O-Ph-A¹-Ph-A²-Ph-A³-Ph-A⁴-Ph-O—R² (Formula 4)
R¹—O-Ph-A¹Ph-A²-Ph-A³-Ph-A⁴-Ph-A⁵-Ph-O—R² (Formula 5)
R¹—O-Ph-A¹-Ph-A²-Ph-A³-Ph-A⁴-Ph-A⁵-Ph-A⁶-Ph-O—R² (Formula 6)
R¹—O-Ph-A¹-Ph-A²-Ph-A³-Ph-A⁴-Ph-A⁵-Ph-A⁶-Ph-A⁷-Ph-O—R² (Formula 7)
R¹—O-Ph-A¹-Ph-A²-Ph-A³-Ph-A⁴-Ph-A⁵-Ph-A⁶-Ph-A⁷-Ph-A⁸-Ph-O—R² (Formula 8)
R¹—O-Ph-A¹-Ph-A²-Ph-A³-Ph-A⁴-Ph-A⁵-Ph-A⁶-Ph-A⁷-Ph-A⁸-Ph-A⁹-Ph-O—R² (Formula 9)
R¹—O-Ph-A¹-Ph-A²-Ph-A³-Ph-A⁴-Ph-A⁵-Ph-A⁶-Ph-A⁷-Ph-A⁸-Ph-A⁹-Ph-A¹⁰-Ph-O—R² (Formula 10)
wherein Ph is a phenyl group without substitution or a phenyl group substituted with NO₂, OH, OCH₃, CH₃, CF₃, F, Cl, or Br;
A is —C≡C—;
each of A₁, A₂, A₃, A₄, A₅, A⁶, A⁷, A⁸, A⁹, and A¹⁰ is independently of —CH₂—, —O—, —(C═O)—, —(CH═CH)—, —C≡C—, —O—(C═O)—, —(NH)—(C+O)—, or a single bond;
each of R¹ and R² is independently of —R³—O—(C═O)—C═CH₂, and R³ is C₂-C₁₂ alkylene group.

3. The prepreg as claimed in claim 1, wherein the reinforcing material comprises glass, ceramic, carbon material, resin, or combinations thereof, and the reinforcing material has a form of fibers, powders, sheets, fabrics, or combinations thereof.

4. A method of forming a prepreg, comprising:
combining a varnish and a reinforcing material to form a film, wherein the varnish comprises a photo initiator, a solvent, and a monomer, an oligomer, or combinations thereof of an organic rod-like molecule,
wherein the organic rod-like molecule has at least one photo-polymerizable group, the organic rod-like molecule has a magnetic susceptibility along its long-axis direction (M1) greater than a magnetic susceptibility along other directions (M2), and the magnetic susceptibility ratio (M1/M2) is greater than 0.01 and less than 1,
applying a magnetic field to the film for arranging the organic rod-like molecule, such that the long-axis of the organic rod-like molecule is parallel to the magnetic field and vertical to the surface of the film, wherein the magnetic field is along a direction vertical to the surface of the film; and
exposing the film to UV radiation, such that the organic rod-like molecule arranged by the magnetic field is polymerized to form a polymer,
wherein the polymer and the reinforcing material are composited to form a prepreg.

5. The method as claimed in claim 4, wherein the organic rod-like molecule is one of Formulae 1 to 10 or combinations thereof:
R¹—O-Ph-A⁰-Ph-O—R² (Formula 1)
R¹—O-Ph-A¹-Ph-A²-Ph-O—R² (Formula 2)
R¹—O-Ph-A¹-Ph-A²-Ph-A³-Ph-O—R² (Formula 3)
R¹—O-Ph-A¹-Ph-A²-Ph-A³-Ph-A⁴-Ph-O—R² (Formula 4)
R¹—O-Ph-A¹-Ph-A²-Ph-A³-Ph-A⁴-Ph-A⁵-Ph-O—R² (Formula 5)
R¹—O-Ph-A¹-Ph-A²-Ph-A³-Ph-A⁴-Ph-A⁵-Ph-A⁶-Ph-O—R² (Formula 6)
R¹—O-Ph-A¹-Ph-A²-Ph-A³-Ph-A⁴-Ph-A⁵-Ph-A⁶-Ph-A⁷-Ph-O—R² (Formula 7)
R¹—O-Ph-A¹-Ph-A²-Ph-A³-Ph-A⁴-Ph-A⁵-Ph-A⁶-Ph-A⁷-Ph-A⁸-Ph-O—R² (Formula 8)
R¹—O-Ph-A¹-Ph-A²-Ph-A³-Ph-A⁴-Ph-A⁵-Ph-A⁶-Ph-A⁷-Ph-A⁸-Ph-A⁹-Ph-O—R² (Formula 9)
R¹—O-Ph-A¹-Ph-A²-Ph-A³-Ph-A⁴-Ph-A⁵-Ph-A⁶-Ph-A⁷-Ph-A⁸-Ph-A⁹-Ph-A¹⁰-Ph-O—R² (Formula 10)
wherein Ph is a phenyl group without substitution or a phenyl group substituted with NO₂, OH, OCH₃, CH₃, CF₃, F, Cl, or Br;
A¹ is —CF≡C—;
each of A¹, A², A³, A⁴, A⁵, A⁶, A⁷, A⁸, A⁹, and A¹⁰ is independently of —CH₂—, —O—, —(C═O)—, —(CH═CH)—, —C≡C—, —O—(C═O)—, —(NH)—(C═O)—, or a single bond;
each of R¹and R² is independently of —R³—O—(C═O)—C═CH₂, and R³ is C₂-C₁₂ alkylene group.

6. The method as claimed in claim 4, wherein the reinforcing material comprises glass, ceramic, carbon material, resin, or combinations thereof, and the reinforcing material has a form of fibers, powders, sheets, fabrics, or combinations thereof.

7. The method as claimed in claim 4, wherein the magnetic field has a strength of 0.1 T to 10 T.

8. The method as claimed in claim 4, being a continuous process.

9. The method as claimed in claim 8, wherein the continuous process is a roll-to-roll process.

10. The method as claimed in claim 4, wherein the step of combining the varnish and the reinforcing material to form the film comprises:
dispersing the reinforcing material in the varnish, and
coating the dispersion on a carrier.

11. The method as claimed in claim 4, wherein the step of combining the varnish and the reinforcing material to form the film comprises:
impregnating the reinforcing material into the varnish.

12. The method as claimed in claim 4, wherein the step of combining the varnish and the reinforcing material to form the film comprises:
coating the varnish on the reinforcing material.
